(19) United States
(12) Patent Application Publication
(10) Pub. No.: US 2022/0042951 A1
(43) Pub. Date: Feb. 10, 2022

(54) METHOD FOR RECONSTRUCTING A THREE-DIMENSIONAL SURFACE USING AN ULTRASONIC MATRIX SENSOR

(71) Applicant: COMMISSARIAT A L'ENERGIE ATOMIQUE ET AUX ENERGIES ALTERNATIVES, Paris (FR)

(72) Inventors: Ekaterina IAKOVLEVA, Paris (FR); David ROUE, Limours (FR)

(73) Assignee: COMMISSARIAT A L'ENERGIE ATOMIQUE ET AUX ENERGIES ALTERNATIVES, Paris (FR)

(21) Appl. No.: 17/414,230

(22) PCT Filed: Dec. 17, 2019
(86) PCT No.: PCT/FR2019/053100

§ 371 Date: Jun. 15, 2021

(30) Foreign Application Priority Data
Dec. 17, 2018 (FR) 1873113

(51) Int. Cl. G01N 29/06; G01N 29/04; G01N 29/11; G01N 29/26; G01N 29/265; G01S 15/89; G06T 11/00

(52) U.S. Cl. CPC G01N 29/069; G01N 29/043; G01N 29/0654; G01N 29/11; G01N 29/262; G01N 2291/2693; G01S 15/8925; G01S 15/8993; G06T 11/003; G01N 2291/045; G01N 2291/106; G01N 29/265

(57) ABSTRACT

A method for reconstructing a three-dimensional surface of a part using an ultrasonic matrix sensor including scanning the three-dimensional surface using a matrix sensor at different measurement points located at the intersection of scanning rows and of increment rows at each measurement point, acquiring a temporal row image representing a reflected wave amplitude received by each element from a selected row of the matrix sensor and acquiring a temporal column image representing a reflected wave amplitude received by each element from a selected column of the matrix sensor, constructing a two-dimensional row image for each scanning row on the basis of the temporal row images constructing a two-dimensional column image for each increment row on the basis of the temporal column images, and constructing a three-dimensional image on the basis of the two dimensional row images and of the two-dimensional column images.

### TECHNICAL FIELD

The invention lies in the field of non-destructive testing by ultrasound. It relates to a method for reconstructing a three-dimensional surface of a part using an ultrasonic matrix sensor.

The invention applies in particular to reconstructing the surface of an industrial part with a view to implementing ultrasonic non-destructive testing. The purpose of non-destructive testing is to detect defects in the industrial part, for example an element of an aircraft turbine engine such as a blade.

### PRIOR ART

In the field of ultrasonic non-destructive testing, the surface condition of the part to be tested greatly influences the quality of the examination. Using a matrix sensor reduces the impact of this parameter. Such a sensor is in fact capable of applying delay laws to the emission and reception of ultrasonic signals in order to orient the propagation axis of the ultrasonic beams perpendicular to the surface of the part at the point of impact. The amplitude of the reflected ultrasonic signals received by the matrix sensor is then maximum. Nevertheless, adapting the ultrasonic beam requires precise knowledge of the geometry of the part. Thus, prior to the implementation of the non-destructive testing strictly speaking, determining the geometry of the surface of the part to be tested is necessary.

Various solutions that can be used on an industrial scale have been proposed. The majority of these solutions are based on linear multielement sensors and make it possible to study only two-dimensional variations of the surface. In other words, the variations in height of the surface are determined only along a single axis. By way of illustration, the doctoral thesis of Leonard Le Jeune: “Planar wave emission ultrasonic imaging for testing complex structures in immersion”, Paris 7, describes an adaptive ultrasonic testing method with a linear multi-element sensor in immersion. The two-dimensional surface of a part is extracted in real time using a technique known as “full matrix capture” (FMC), and then an ultrasonic image of the volume of the part is reconstructed by a technique known as “total focusing method” (TFM). In this method, the ultrasonic image represents only the volume situated under the surface of the sensor. The article by F. Lasserre et al: “Industrialization of a Large Advanced Ultrasonic Flexible Probe for Non-destructive Testing of Austenitic Steel Pieces with Irregular Surface”, Journal of Civil Engineering and Architecture, November 2017, p. 933-942, describes an adaptive ultrasonic testing method with a linear multi-element transducer in contact with the part. The two-dimensional surface is extracted using an optical measurement system and then the delay laws are adapted in real time to generate an ultrasonic beam focused at oblique incidence.

Solutions have also been proposed in order to reconstruct three-dimensional surfaces. For example, the application WO 2015/075121 A1 describes a method for reconstructing a three-dimensional surface using a matrix sensor in a static position or using a single-element sensor moving along two axes of a plane. In the first case, the matrix sensor can image only a relatively small surface, corresponding substantially to the surface of the matrix sensor. In the second case, the sensor must be moved in numerous positions, making the acquisition period relatively long for extended surfaces. Furthermore, the sensor must be moved with a positioning system having high precision. Failing this, the precision of the reconstruction is degraded. In practice, in both cases, reconstructing a three-dimensional surface with extended dimensions is complex to implement. Another solution would consist of using a matrix sensor and moving it in various measuring positions along two movement axes. An FMC acquisition could be made at each position, and then a reconstruction by the TFM technique could be implemented using all the FMC acquisitions. However, an FMC acquisition involves, for each measurement position, the individual sending of an ultrasonic signal by each of the elements of the matrix sensor, and the reception of an echo of this ultrasonic signal by all the elements of the matrix sensor. Thus, for a sensor with N elements, each measurement position gives rise to a set of N² elementary signals. The volume of data to be processed is quickly considerable for a matrix sensor and extended surfaces, making the method incompatible with an industrial application.

One aim of the invention is therefore to propose a technique for reconstructing a relatively extended three-dimensional surface using an ultrasonic matrix sensor.

### DESCRIPTION OF THE INVENTION

For this purpose, the invention is based on a scanning of the three-dimensional surface with a matrix sensor and a collection of data “in a cross” at each measurement point. In practice, for each measurement point, the reconstruction method according to the invention comprises the sending of a first incident wave by one or more elements of a row of the matrix sensor, the reflection of this first incident wave, referred to as the “first reflected wave”, being received and converted into temporal signals by all the elements of this row. A second incident wave is then sent by one or more elements of a column of the matrix sensor, and the reflection of this second incident wave, referred to as the “second reflected wave”, is received and converted into temporal signals by all the elements of this column. The reconstruction method next comprises generating two-dimensional row images in first planes parallel to the rows of elements of the matrix sensor and generating two-dimensional images of the column in second planes parallel to the columns of elements of the matrix sensor. Each two-dimensional row image is generated from temporal signals corresponding to the first plane in question. Likewise, each two-dimensional column is generated from the temporal signals corresponding to the second plane in question. Finally, a three-dimensional image is constructed by merging the two-dimensional row images and the two-dimensional column images.

More precisely, the object of the invention is a method for reconstructing a three-dimensional surface of a part using a matrix sensor comprising a plurality of elements E(m, n) arranged in rows and columns, each element being arranged to be able to emit an incident wave in the direction of the part and to generate a signal representing a reflected wave received by said element. The method includes the following steps:
scanning the three-dimensional surface with the matrix sensor, the matrix sensor being moved in a plurality of measurement points O(i, j), each measurement point being defined by the intersection of a scanning line Lᵢ, among a set of scanning lines parallel to the rows of elements of the matrix sensor, and an increment line Lᵢ, among a set of increment lines parallel to the columns of elements of the matrix sensor,
at each measurement point O(i, j), successively implementing

an acquisition of a temporal row image SL_{i,j}(mₛ, t) comprising the emission of an incident wave by one or more elements of a selected row mₛ of the matrix sensor and the generation, for each of the elements E(mₛ, nᵣ) of the selected row, of a temporal signal representing an amplitude over time of a reflected wave received by said element, the temporal row image SL_{i,j}(mₛ, t) being formed by all the temporal signals of the elements of the selected row mₛ, and

an acquisition of a temporal column image SC_{i,j}(nₛ, t) comprising the emission of an incident wave by one or more elements of a selected column nₛ of the matrix sensor and the generation, for each of the elements E(mₜ, nₛ) of the selected column, of a temporal signal representing an amplitude over time of a reflected wave received by said element, the temporal column image SC_{i,j}(nₛ, t) being formed by all the temporal signals of the elements of the selected column nₛ,
for each scanning line Lᵢ, constructing, from all the temporal row images SL_{i,j}(mₛ, t) corresponding to said scanning line Lᵢ, a two-dimensional image of the row Xᵢ in a plane Pᵢ(mₛ) passing through the elements of the selected row mₛ, each two-dimensional image of the row Xᵢ being defined by a reflected wave amplitude at various points of the plane Pᵢ(mₛ),
for each increment line Lᵢ, constructing, from all the temporal column images SC_{i,j}(nₛ, t) corresponding to said increment line Lⱼ, a two-dimensional column image Yⱼ in a plane Pⱼ(nₛ) passing through the elements of the selected column nₛ, each two-dimensional column image Yⱼ being defined by a reflected wave amplitude at various points of the plane Pⱼ(nₛ), and
from the two-dimensional row images Xᵢ and the two-dimensional column images Yⱼ, constructing a three-dimensional image of the part, the three-dimensional image being defined by a reflected wave amplitude at various points of a volume containing the two-dimensional row images Xᵢ and the two-dimensional column images Yⱼ.

The elements of the matrix sensor are for example arranged in a plane, the rows and columns of elements being aligned on straight lines. The matrix sensor comprises for example a set of elements arranged in sixteen rows and sixteen columns. Nevertheless, in general terms, the sensor comprises a set of elements E(m, n) arranged in M rows and N columns, with M and N two integers greater than or equal to three.

It should be noted that, at each measurement point O(i, j), the same row and the same column of elements can be selected for acquiring temporal row images SL_{i,j}(mₛ, t) and temporal column images SC_{i,j}(nₛ, t). Thus only the elements of this row and of this column are useful for the three-dimensional surface reconstruction method according to the invention. In place of a matrix sensor, a sensor comprising a single row and a single column of elements, for example in a cross or in a T, could therefore be used. Nevertheless, a matrix sensor has the advantage of being able to be used both for reconstructing the three-dimensional surface of the part and for a subsequent step of ultrasonic non-destructive testing of the part.

The method according to the invention is adapted for reconstructing plane surfaces and curved surfaces, including when they have local three-dimensional deformations. The scanning and increment lines are preferably adapted accordingly. In particular, the scanning lines may be straight lines or curved lines. Likewise, the increment lines may be straight lines or curved lines. Each scanning line and/or each increment line forms for example an ellipse, a circle, a portion of an ellipse or a portion of a circle. By way of example, for a cylindrical surface of revolution, the scanning lines may be straight lines parallel to the axis of revolution of the cylindrical surface and the increment lines may be circles centred on the axis of revolution. For an O-ring surface, the scanning lines may be circles centred on the axis of revolution of the major radius of curvature and the increment lines may be circles centred on the axis of revolution of the minor radius of curvature. When the scanning lines and/or the increment lines are curved, the parallelism thereof with the elements of the sensor is considered locally at the sensor.

The scanning is preferentially implemented so that the matrix sensor is positioned only once on each measurement point. The matrix sensor can thus be moved along each scanning line and stopped at each point of intersection with an increment line. The position of the matrix sensor can be defined by the position of one of the elements thereof, for example the element at the intersection of the selected row and column.

According to a particular embodiment, the scanning of the three-dimensional surface is implemented with a scanning step pᵢ less than a length of a column of elements of the matrix sensor and/or with an increment step pⱼ less than a length of a row of elements of the matrix sensor. The scanning step pᵢ is defined as a distance separating two adjacent scanning lines and the increment step pᵢ is defined as a distance separating two adjacent increment lines. The use of a step less than the length of the elements makes it possible to obtain an overlap of zones imaged between two adjacent measurement points, and therefore to improve the quality of the reconstruction.

According to a first variant embodiment, each acquisition of a temporal row image SL_{i,j}(mₛ, t) comprises the emission of an incident wave successively by each of the elements E(nₛ, nₜ) of the selected row mₛ and the generation, for each pair of elements {E(mₛ, nₜ); E(mₛ, nᵣ)} of the selected row mₛ, the element E(mₛ, nₜ) designating the element located at the row mₛ and at the column nₜ that emitted the incident wave, and the element E(mₛ, nᵣ) designating the element located at the row mₛ and at the column nᵣ that received the reflected wave, of a temporal signal SL_{i,j}(mₛ, nₜ, nᵣ, t) representing an amplitude over time of a reflected wave received by said element E(mₛ, nᵣ), the temporal row image SL_{i,j}(mₛ, t) being formed by all the temporal signals SL_{i,j}(mₛ, nₜ, nᵣ, t) of the selected row mₛ.

According to a second variant embodiment, compatible with the first variant, each acquisition of a temporal column image SC_{i,j}(nₛ,t) comprises the emission of an incident wave successively by each of the elements E(mₜ, nₛ) of the selected column nₛ and the generation, for each pair of elements {E(mₜ, nₛ); E(mᵣ, nₛ)} of the selected column nₛ, the element E(mₜ, nₛ) designating the element located at the row mₜ and at the column nₛ that emitted the incident wave and the element E(mᵣ, nₛ) designating the element situated at the row mᵣ and at the column nₛ that received the reflected wave, of a temporal signal SC_{i,j}(mₜ, mᵣ, nₛ, t) representing an amplitude over time of a reflected wave received by said element E(mᵣ,nₛ), the temporal column image SC_{i,j}(nₛ, t) being formed by all the temporal signals SC_{i,j}(mₜ, mᵣ, nₛ,t) of the selected column nₛ.

The acquisitions of the first and second variant embodiments could be termed full matrix capture (FMC) considering that the sensor consists solely of the selected row and column.

According to these first and second variant embodiments, the construction of each two-dimensional row image Xᵢ in the plane Pᵢ(mₛ) may comprise an implementation of a total focusing method (TFM) and the construction of each two-dimensional column image Yⱼ in the plane Pⱼ(nₛ) may comprise an implementation of a total focusing method (TFM). For an implementation of a total focusing method in a plane, reference can be made in particular to the document by Caroline Holmes et al: “Post-processing of the full-matrix of ultrasonic transmit-receive array data for non-destructive evaluation”, NDT&E International 38, 2005, 701-711.

According to a third variant embodiment, each acquisition of a temporal row image SL_{i,j}(mₛ, t) comprises the successive emission of a plurality of incident waves by a plurality of elements of the selected row mₛ, each incident wave being emitted with a predetermined angle of incidence θₖ, and the generation of a temporal signal SL_{i,j}(mₛ, nᵣ, θₖ, t) for each element E(mₛ, nᵣ) of the selected row mₛ and for each incident wave with the predetermined angle of incidence θₖ, the element E(mₛ, nᵣ) designating the element located at the row mₛ, and at the column 12, that received the reflected wave, the temporal row image SL_{i,j}(mₛ, t) being formed by all the temporal signals SL_{i,j}(mₛ, nᵣ, θₖ, t) of the selected row mₛ.

According to a fourth variant embodiment, each acquisition of a temporal column image SC_{i,j}(nₛ, t) comprises the successive emission of a plurality of incident waves by a plurality of elements of the selected column nₛ, each incident wave being emitted with a predetermined angle of incidence θₖ, and the generation of a temporal signal SC_{i,j}(mᵣ, nₛ, θₖ, t) for each element E(mᵣ, nₛ) of the selected row and for each incident wave with the predetermined angle of incidence θₖ, the element E(mᵣ, nₛ) designating the element located at the row mᵣ and at the column nₛ that received the reflected wave, the temporal column image SC_{i,j}(nₛ, t) being formed by all the temporal signals SC_{i,j}(mᵣ, nₛ, θₖ, t) of the selected column nₛ.

The third and fourth variant embodiments make it possible to generate incident waves with various angles of incidence and focused at various reception points.

According to these third and fourth variant embodiments, constructing each two-dimensional row image Xᵢ and constructing each two-dimensional column image Y may comprise an implementation of a plane wave imaging (PWI) method. For implementing a plane wave imaging method in one plane, reference can be made in particular to the document by L. Le Jeune et al: “Plane Wave Imaging for Ultrasonic Inspection of Irregular Structures with High Frame Rates”, AIP Conference Proceedings 1706, 2016.

Constructing each two-dimensional row image Xᵢ may comprise detecting contours, so as to determine a profile of the part in the plane Pᵢ(mₛ) of said two-dimensional row image Xᵢ, and/or constructing each two-dimensional column image Yⱼ may comprise detecting contours, so as to determine a profile of the part in the plane Pⱼ(nₛ) of said two-dimensional column image Yⱼ. According to a particular embodiment, the contours are detected by a thresholding, the reflected wave amplitude at each point of a plane Pᵢ(mₛ) or Pⱼ(nₛ) being set to zero if it is below a predetermined threshold, and unchanged otherwise. The predetermined threshold is for example determined as being equal to half the greatest reflected wave amplitude in the plane Pᵢ(mₛ) or Pⱼ(nₛ) in question.

The reconstruction method according to the invention may include, at each measurement point O(i, j), an acquisition of a plurality of temporal images of rows SL_{i,j}(mₛₖ, t) for various selected rows mₛₖ and/or an acquisition of a plurality of temporal images of columns SC_{i,j}(nₛₖ,t) for various selected columns nₛₖ. Thus a two-dimensional row image X_{i,k} can be constructed for each scanning line Lᵢ and for each selected row mₛₖ in a plane Pᵢ(mₛₖ) passing through the elements of the selected row mₛₖ. Likewise, a two-dimensional column image Y_{j,k} can be constructed for each increment line Lⱼ and for each selected column nₛₖ in a plane Pⱼ(nₛₖ) passing through the elements of the selected column nₛₖ. Acquiring a plurality of temporal row and/or column images for each measurement point makes it possible to improve the precision of the reconstruction and/or to improve the scanning step and the increment step.

Thus, more precisely, the reconstruction method may include the following steps:
at each measurement point O(i,j), successively implementing an acquisition of a plurality of temporal row images SL_{i,j}(mₛₖ, t) for various selected rows mₛₖ, each acquisition of a temporal row image SL_{i,j}(mₛₖ, t) comprising the emission of an incident wave by one or more elements E(mₛₖ, nₜ) of the selected row mₛₖ of the matrix sensor and the generation, for each of the elements E(mₛₖ, nᵣ) of the selected row mₛₖ, of a temporal signal representing an amplitude over time of a reflected wave received by said element, each temporal row image SL_{i,j}(mₛₖ, t) being formed by all the temporal signals of the elements of said selected row mₛₖ,
for each scanning line Lᵢ and for each of the selected rows mₛₖ, constructing, from all the temporal images of the line SL_{i,j}(mₛₖ, t) corresponding to said scanning line Lᵢ and to said selected row mₛₖ, a two-dimensional row image X_{i,k} in a plane Pᵢ(mₛₖ) passing through the elements of the selected row mₛₖ, each two-dimensional row image X_{i,k} being defined by a reflected wave amplitude at various points of the plane Pᵢ(mₛₖ).

The reconstruction method may also include the following steps:
at each measurement point O(i, j), successively implementing an acquisition of a plurality of temporal column images SC_{i,j}(nₛₖ, t) for various selected columns nₛₖ, each acquisition of a temporal column image SC_{i,j}(nₛₖ, t) comprising the emission of an incident wave by one or more elements of the selected column nₛₖ of the matrix sensor and the generation, for each of the elements E (mᵣ, nₛₖ) of the selected column nₛₖ, of a temporal signal representing an amplitude over time of a reflected wave received by said element, each temporal column image SC_{i,j}(nₛₖ, t) being formed by all the temporal signals of the elements of said selected column nₛₖ,
for each increment line Lⱼ and for each of the selected columns nₛₖ, constructing, from all the temporal column images SC_{i,j}(nₛₖ, t) corresponding to said increment line Lᵢ and to said selected column nₛₖ, a two-dimensional column image Y_{j,k} in a plane Pⱼ(nₛₖ) passing through the elements of the selected column nₛₖ, each two-dimensional column image Y_{j,k} being defined by a reflected wave amplitude at various points of the plane Pⱼ(nₛₖ).

### BRIEF DESCRIPTION OF THE DRAWINGS

Other features, details and advantages of the invention will emerge from a reading of the following description given solely by way of example and referring to the accompanying drawings, on which:

FIG. 1A shows an example of a matrix sensor, a row of which is selected for implementing the method for reconstructing a three-dimensional surface of a part according to the invention;

FIG. 1B shows the matrix sensor of FIG. 1A, a column of which is selected for implementing the reconstruction method according to the invention;

FIG. 2 shows an example of steps of the reconstruction method according to the invention;

FIG. 3A shows an example of scanning of a plane surface;

FIG. 3B shows an example of scanning of a surface forming a portion of a torus;

FIG. 4 illustrates schematically the formation of two-dimensional row images and two-dimensional column images;

FIG. 5A shows an example of a two-dimensional row image obtained for the surface in FIG. 3B at a scanning line not passing through a local deformation;

FIG. 5B shows an example of a two-dimensional row image obtained for the surface in FIG. 3B at a scanning line passing through a local deformation;

FIG. 6A shows an example of a two-dimensional column image obtained for the surface in FIG. 3B at an increment line not passing through a local deformation;

FIG. 6B shows an example of a two-dimensional column image obtained for the surface in FIG. 3B at an increment line passing through a local deformation;

FIG. 7 shows an example of a three-dimensional image obtained for the surface in FIG. 3B from two-dimensional row images and two-dimensional column images;

FIG. 8 shows an example of an extrapolated three-dimensional image obtained from the three-dimensional image in FIG. 7.

### DETAILED DESCRIPTION OF PARTICULAR EMBODIMENTS

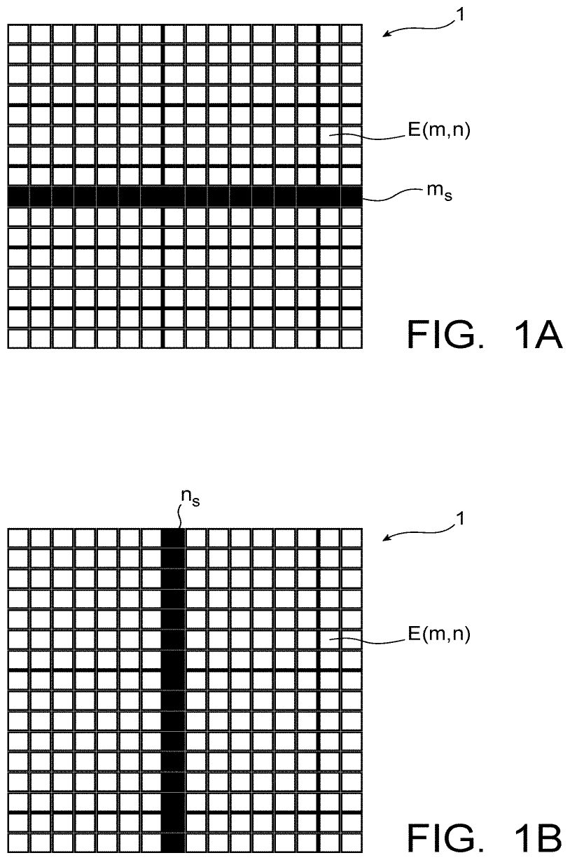

FIGS. 1A and 1B show an example of an ultrasonic matrix sensor 1 able to be used in a method for reconstructing a three-dimensional surface of a part according to the invention. The matrix sensor 1 comprises a set of sixteen rows by sixteen columns of elements E(m,n), with m and n two integers such that 1≤m≤16 and 1≤n≤16. In general terms, the invention may be based on any ultrasonic matrix sensor comprising a set of M rows by N columns of elements, with M and N two integers greater than or equal to three. Each element E(m,n) of the matrix sensor 1 is arranged to be able to emit an incident signal, in the form of an incident wave, in the direction of a surface of a part to be reconstructed, and to be able to receive a reflected wave and to convert it into a signal representing an amplitude of this reflected wave over time. When the elements are considered during the emission of an incident wave, they are denoted E(mₜ, nₜ) and, when they are considered during the reception of a reflected wave, they are denoted E(mᵣ, nᵣ). For the reconstruction method according to the invention, one of the rows and one of the columns are selected. For the remainder of the description, the selected row is denoted mₛ and the selected column nₛ. Optionally, a plurality of rows mₛₖ and a plurality of columns nₛₖ may be selected successively. FIG. 1A shows the selection of the ninth row (mₛ=9) and FIG. 1B shows the selection of the eighth column (nₛ=8).

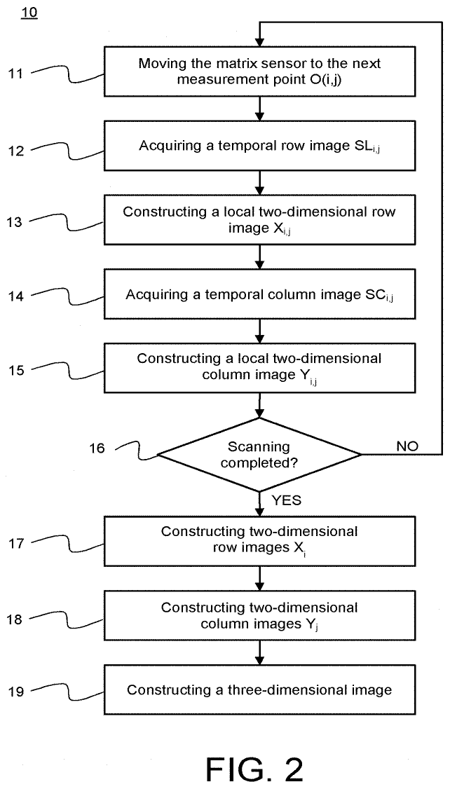

FIG. 2 shows an example of a method for reconstructing a three-dimensional surface of a part according to the invention. The method 10 comprises an iteration of the following steps for various measurement points O(i,j): a step 11 of moving the matrix sensor 1 to the measurement point O(i,j) in question, a step 12 of acquiring a temporal row image SL_{i,j}, a step 13 of constructing a local two-dimensional row image X_{i,j}, a step 14 of acquiring a temporal column image SC_{i,j}, a step 15 of constructing a local two-dimensional column image Y_{i,j} and a step 16 of checking the completeness of the scanning. After iteration of these steps 11 to 15 at each of the measurement points O(i, j), i.e. after scanning the whole of the three-dimensional surface to be reconstructed, the method comprises a step 17 of constructing two-dimensional row images Xᵢ, a step 18 of constructing two-dimensional column images Yⱼ and a step 19 of constructing a three-dimensional image.

The steps 11 and 16 give rise to a scanning of the three-dimensional surface with the matrix sensor 1. This scanning comprises moving the matrix sensor 1 at each measurement point O(i, j) where i designates a scanning line Lᵢ among a set of scanning lines parallel to each other, and j designates an increment line Lⱼ among a set of increment lines parallel to each other. Each measurement point O(i, j) is thus defined as the intersection of a scanning line Lᵢ and of an increment line Lⱼ. The scanning lines Lᵢ and the increment lines Lⱼ are preferably adapted to the three-dimensional surface to be reconstructed.

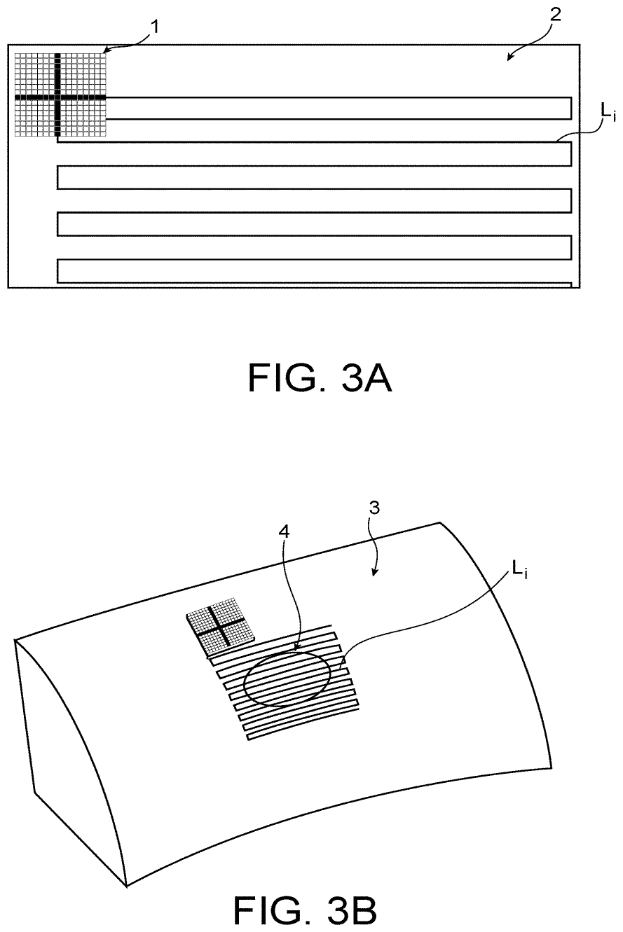

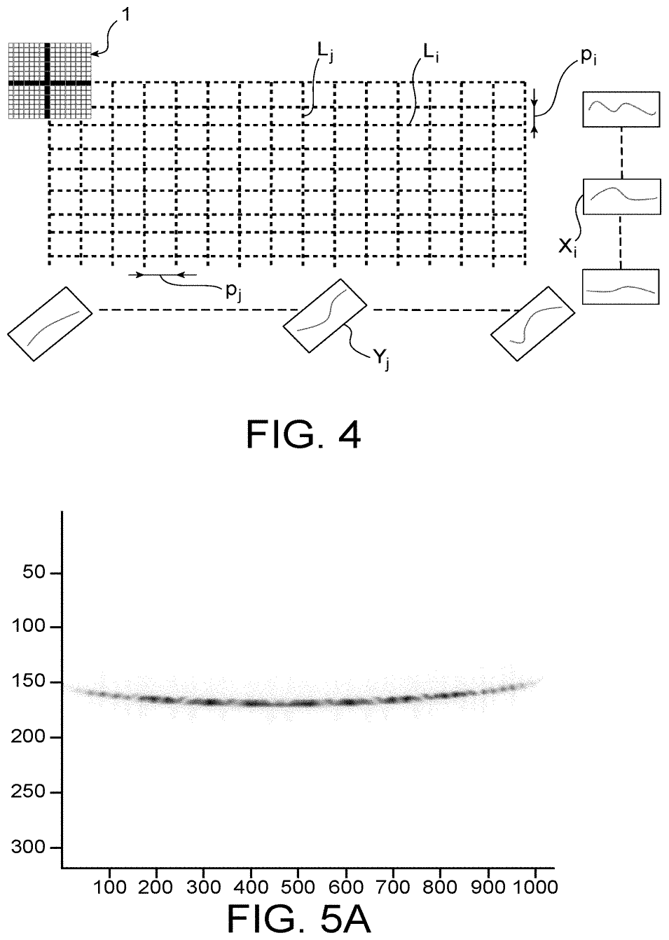

FIG. 3A shows a first example of scanning of a three-dimensional surface by the matrix sensor 1 in the case of a substantially plane three-dimensional surface 2 and FIG. 3B shows a second example of scanning in the case of a three-dimensional surface 3 forming a portion of a torus. The three-dimensional surface 3 includes a zone 4 locally deformed by a hollow. In each case, this movement made by the matrix sensor 1 for passing through the various measurement points O(i, j) successively follows the various scanning lines Lᵢ, the acquisition steps 12 and 14 being implemented after each movement of the matrix sensor by an increment step pⱼ. At the end of each scanning line Lᵢ, the matrix sensor is moved to a following scanning line Lᵢ₊₁, the adjacent scanning lines Lᵢ being separated by a scanning step pᵢ, shown in FIG. 4. In FIG. 3A, the scanning lines Lᵢ are straight lines parallel to each other and to the rows of elements E(m,n) of the matrix sensor 1, and the increment lines Lⱼ are straight lines parallel to each other and to the columns of elements E(m, n) of the matrix sensor 1. In FIG. 3B, the scanning lines Lᵢ form portions of a circle centred on the axis of revolution of the major radius of curvature of the torus and the increment lines Lᵢ form portions of a circle centred on the axis of revolution of the minor radius of curvature of the torus. Having regard to the respective dimensions of the matrix sensor 1 and of the torus, the scanning lines Lᵢ can be considered to be parallel to the rows of elements E(m, n) of the matrix sensor 1 and the increment lines L₁ can be considered to be parallel to the columns of elements E(m,n). It may be noted that the matrix sensor 1 does not physically follow the increment lines Lⱼ during the scanning. Nevertheless, the matrix sensor 1 being moved with a regular increment step pⱼ along the scanning lines Lᵢ, it passes through each of the measurement points O(i, j) following the increment lines Lⱼ. The increment step pⱼ, shown in FIG. 4, thus defines a distance between two adjacent increment lines.

The step 12 of acquiring a temporal row image SL_{i,j} for the measurement point O(i, j) in question comprises emitting an incident wave successively by each of the elements E(mₛ, nₜ) of a selected row mₛ of the matrix sensor 1, and generating a temporal signal SL_{i,j}(mₛ, nₜ, nᵣ, t) for each pair of elements {E(mₛ, nₜ); E(mₛ, nᵣ)} of the selected row mₛ, the element E(mₛ, nₜ) designating the element located at the row mₛ and at the column nₜ that emitted the incident wave and the element E(mₛ, nᵣ) designating the element situated at the row mₛ and at the column nᵣ that received the reflected wave. The signal SL_{i,j}(mₛ, nₜ, nᵣ, t) represents an amplitude over time t of the reflected wave received by the element E(mₛ, nᵣ) and resulting from a reflection of the incident wave emitted by the element E(mₛ, nₜ). The temporal row image for the measurement point O(i, j), denoted SL_{i,j}(mₛ, t) and abbreviated to SL_{i,j}, is formed by all the temporal signals SL_{i,j}(mₛ, nₜ, nᵣ, t) generated for the various pairs of elements {E(mₛ, nₜ); E(mₛ, nᵣ)} of the selected row mₛ.

The step 13 of constructing a local two-dimensional row image X_{i,j} for the point O(i,j) in question comprises determining, from the corresponding temporal row image SL_{i,j}(mₛ, t), a reflected wave amplitude at various points of a plane Pᵢ(mₛ) passing through the elements E(mₛ, n) of the selected row mₛ. The plane Pᵢ(mₛ) is perpendicular to the columns of the matrix sensor 1. According to a particular embodiment, the local two-dimensional row image X_{i,j} is constructed by a total focusing method (TFM).

The step 14 of acquiring a temporal column image SC_{i,j} for the measurement point O(i, j) in question comprises sending an incident wave successively by each of the elements E(mₜ, nₛ) of a selected column nₛ of the matrix sensor 1, and generating a temporal signal SC_{i,j}(mₜ, mᵣ, nₛ, t) for each pair of elements {E(mₜ, nₛ); E(mᵣ,nₛ)} of the selected column nₛ, the element E(mₜ, nₛ) designating the element located at the row mₜ and at the column nₛ that emitted the incident wave and the element E(mᵣ, nₛ) designating the element located at the row mᵣ and at the column nₛ that received the reflected wave. The signal SC_{i,j}(mₜ, mᵣ, nₛ, t) represents an amplitude over time t of the reflected wave received by the element E(mᵣ, nₛ) and resulting from a reflection of the incident wave emitted by the element E(mₜ, nₛ). The temporal column image for the measurement point O(i, j), denoted SC_{i,j}(nₛ,t) and abbreviated to SC_{i,j}, is formed by all the temporal signals SC_{i,j}(mₜ, mᵣ, nₛ, t) generated for the various pairs of elements {E(mₜ, nₛ); E(mᵣ, nₛ)} of the selected column nₛ.

The step 15 of constructing a local two-dimensional column image Y_{i,j} for the point O(i, j) in question comprises determining, from the corresponding temporal column image SC_{i,j}(nₛ, t), a reflected wave amplitude at various points of a plane Pⱼ(nₛ) passing through the elements E(m, nₛ) of the selected column nₛ. The plane Pⱼ(nₛ) is perpendicular to the rows of the matrix sensor 1. According to a particular embodiment, the local two-dimensional column image Y_{i,j} is constructed by a total focusing method (TFM).

The step 12 of acquiring a temporal row image SL_{i,j} and the step 14 of acquiring a temporal column image SC_{i,j} for a given measurement point O(i, j) are implemented successively so as to avoid interference between the waves emitted by the elements of the selected row and those emitted by the elements of the selected column. The order of these steps may of course be reversed.

Moreover, it has been considered, in each step of acquiring a temporal row or column image, that an incident wave is emitted successively by each of the elements of the row or of the column selected. Nevertheless, each step 12 of acquiring a temporal row image SL_{i,j} may comprise the successive emission of a plurality of incident waves by a plurality of elements of the selected row mₛ, each incident wave being emitted with a predetermined angle of incidence θₖ, and the generation of a temporal signal SL_{i,j}(mₛ, nᵣ, θₖ, t) for each element E(mₛ, nᵣ) of the selected row and for each incident wave. The incident waves may in particular be emitted with angles of incidence different from each other. The temporal row image for the measurement point O(i,j), also denoted SL_{i,j}(mₛ,t) and abbreviated to SL_{i,j}, is then formed by all the temporal signals SL_{i,j}(mₛ, nᵣ, θₖ, t) generated for the various pairs of elements E(mₛ, nᵣ) of the selected row and of incident wave. The step 13 of constructing a local two-dimensional row image X_{i,j} for the point O(i,j) is constructed from the corresponding temporal row image SL_{i,j}(mₛ, t). In a similar manner, each step 14 of acquiring a temporal column image SC_{i,j} may comprise the successive emission of a plurality of incident waves by a plurality of elements of the selected column nₛ, each incident wave being emitted with a predetermined angle of incidence θₖ, and the generation of a temporal signal SC_{i,j}(mᵣ, nₛ, θₖ, t) for each element E(mᵣ, nₛ) of the selected column and for each incident wave. The incident waves may in particular be emitted with angles of incidence different from each other. The temporal column image for the measurement point O(i,j), also denoted SC_{i,j}(nₛ, t) and abbreviated to SC_{i,j}, is then formed by all the temporal signals SC_{i,j}(mᵣ, nₛ, θₖ, t) generated for the various pairs of elements E(mᵣ, nₛ) of the selected column and of incident wave. The step 15 of constructing a local two-dimensional column image Y_{i,j} for the point O(i,j) in question is constructed from the corresponding temporal column image SC_{i,j}(nₛ, t).

The step 16 of checking the completeness of the scanning consists of checking that the matrix sensor has been moved at each measurement point O(i,j) and that a local two-dimensional row image X_{i,j} and a local two-dimensional column image Y_{i,j} have been constructed at each of these points.

The step 17 of constructing two-dimensional row images Xᵢ comprises, for each scanning line Lᵢ, a concatenation of all the local two-dimensional images X_{i,j} of the scanning line Lᵢ in question. Each two-dimensional row image Xᵢ then represents a reflected wave amplitude at various points of the plane Pᵢ(mₛ) passing through the elements E(mₛ, n) of the selected row mₛ. The concatenation is for example implemented by adding the reflected wave amplitude at the various points of the plane Pᵢ(mₛ).

In a similar manner, the step 18 of constructing two-dimensional column images Yⱼ comprises, for each increment line Lⱼ, a concatenation of all the local two-dimensional images X_{i,j} of the increment line Lᵢ in question. Each two-dimensional column image Y then represents a reflected wave amplitude at various points of the plane Pⱼ(nₛ) passing through the elements E(m, nₛ) of the selected column nₛ. The concatenation is for example implemented by adding the reflected wave amplitude at the various points of the plane Pⱼ(nₛ).

FIG. 4 illustrates schematically the formation of the two-dimensional row Xᵢ and column Yⱼ images after scanning of the matrix sensor 1 following the various scanning lines Lᵢ and increment lines Lⱼ. The two-dimensional row images Xᵢ represent the amplitude of the reflection of the incident waves in the planes Pᵢ(mₛ), which constitute planes substantially perpendicular locally to the surface of the part. The two-dimensional column images Yⱼ represent the amplitude of the reflection of the incident waves in the planes Pⱼ(nₛ), which constitute planes substantially perpendicular locally to the surface of the part and to the planes Pᵢ(mₛ).

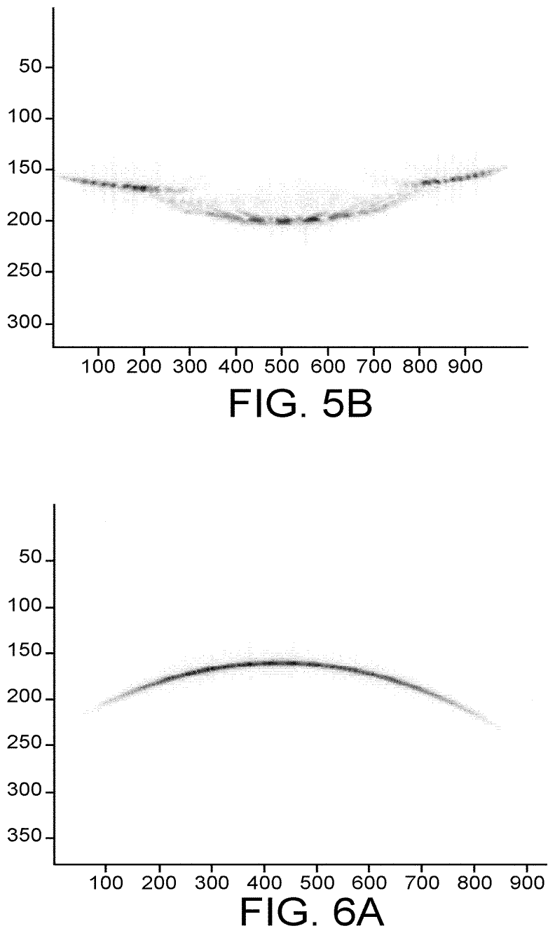

FIGS. 5A and 5B show two examples of two-dimensional row images Xᵢ obtained for the three-dimensional surface 3 shown in FIG. 3B and forming a portion of a torus. These images are obtained by the steps 11 to 18 of the method described above with the use of a total focusing method. FIG. 5A shows a two-dimensional row image Xᵢ for a scanning line Lᵢ not passing through the locally deformed zone 4 and FIG. 5B shows a two-dimensional row image Xᵢ for a scanning line Lᵢ passing through the locally deformed zone 4.

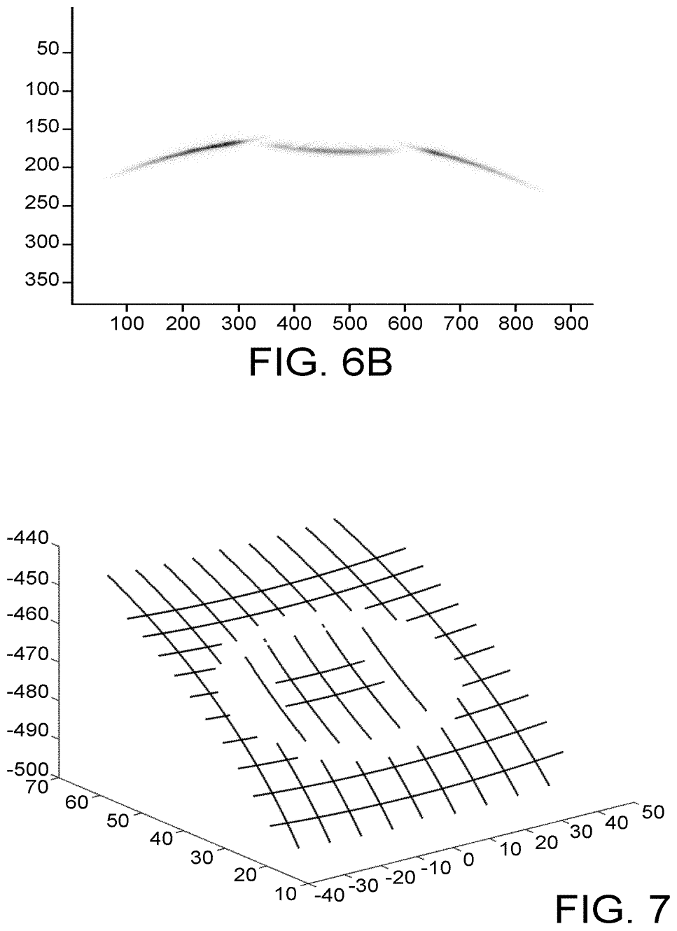

FIGS. 6A and 6B show two examples of two-dimensional column images Yⱼ obtained for the three-dimensional surface 3. These images are obtained by the steps 11 to 18 of the method described above with the use of a total focusing method. FIG. 6A shows a two-dimensional column image Yⱼ for an increment line Lⱼ not passing through the locally deformed zone 4 and FIG. 6B shows a two-dimensional column image Yⱼ for an increment line Lⱼ passing through the locally deformed zone 4.

The step 19 of constructing a three-dimensional image comprises determining, from all the two-dimensional row images Xᵢ and from all the two-dimensional column images Yⱼ a reflected wave amplitude at various points of a volume encompassing the various planes Pᵢ(mₛ) and Pⱼ(nₛ) of these two-dimensional images. In this case, the volume is delimited by the first and last planes Pᵢ(mₛ) and by the first and last planes Pⱼ(nₛ). The three-dimensional image is formed by these reflected wave amplitudes at the various points of the volume. In practice, constructing the three-dimensional image consists for example in merging the two-dimensional row images Xᵢ and column images Yⱼ.

FIG. 7 shows an example of a three-dimensional image obtained for the three-dimensional surface 3 shown in FIG. 3B. It can be observed in this figure that the two-dimensional row images Xᵢ and the two-dimensional column images Yⱼ provide complementary data for constructing the three-dimensional image, more specifically at the locally deformed zone 4, for which an absence of reflected wave can be observed for all the elements of a row of the matrix sensor because of an inclination of the three-dimensional surface 3 located under the matrix sensor 1 in a plane not perpendicular to the plane Pᵢ(mₛ) passing through this row.

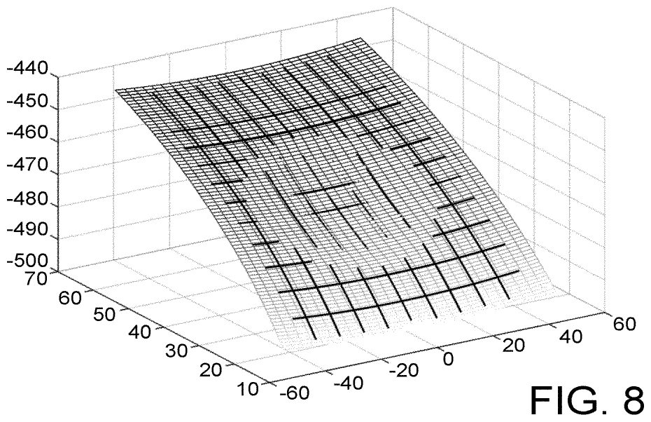

The reconstruction method according to the invention may also include, following the step 19 of constructing the three-dimensional image, a step of extrapolating this three-dimensional image, wherein reflected wave amplitudes are determined for various complementary points of the volume situated between the points of the volume for which a wave amplitude has been determined. FIG. 8 shows an example of an extrapolated three-dimensional image obtained from the three-dimensional image in FIG. 7.

1. A method for reconstructing a three-dimensional surface of a part using a matrix sensor comprising a plurality of elements arranged in rows and columns, each element being arranged to be able to emit an incident wave in the direction of the part and to generate a signal representing a reflected wave received by said element, the method comprising:
scanning the three-dimensional surface with the matrix sensor, the matrix sensor being moved in a plurality of measurement points, each measurement point being defined by the intersection of a scanning line, among a set of scanning lines parallel to the rows of elements of the matrix sensor, and an increment line, among a set of increment lines parallel to the columns of elements of the matrix sensor,
at each measurement point, successively
acquiring a temporal row image comprising emitting an incident wave by one or more elements of a selected row of the matrix sensor and generating, for each of the elements of the selected row, a temporal signal representing an amplitude over time of a reflected wave received by said element, the temporal row image being formed by all the temporal signals of the elements of the selected row, and
acquiring a temporal column image comprising emitting an incident wave by one or more elements of a selected column of the matrix sensor and generating, for each of the elements of the selected column, a temporal signal representing an amplitude over time of a reflected wave received by said element, the temporal column image being formed by all the temporal signals of the elements of the selected column,
for each scanning line, constructing, from all the temporal row images corresponding to said scanning line, a two-dimensional image of the row in a plane passing through the elements of the selected row, each two-dimensional image of the row being defined by a reflected wave amplitude at various points of the plane,
for each increment line, constructing, from all the temporal column images corresponding to said increment line, a two-dimensional column image in a plane passing through the elements of the selected column, each two-dimensional column image being defined by a reflected wave amplitude at various points of the plane, and
from the two-dimensional row images and the two-dimensional column images, constructing a three-dimensional image of the part, the three-dimensional image being defined by a reflected wave amplitude at various points of a volume containing the two-dimensional row images and the two-dimensional column images.

2. The reconstruction method according to claim 1, wherein the scanning lines are straight lines or curved lines, and/or the increment lines are straight lines or curved lines.

3. The reconstruction method according to claim 1, wherein the scanning of the three-dimensional surface is implemented with a scanning step less than a length of a row of elements of the matrix sensor and/or with an increment step less than a length of a column of elements of the matrix sensor.

4. The reconstruction method according to claim 1, wherein each acquisition of a temporal row image comprises emitting an incident wave successively by each of the elements of the selected row and generating, for each pair of elements of the selected row, the first element of the pair designating the element of the pair located at the row and at the column that emitted the incident wave, and the second element of the pair designating the element located at the row and at the column that received the reflected wave, a temporal signal representing an amplitude over time of a reflected wave received by said second element, the temporal row image being formed by all the temporal signals of the selected row.

5. The reconstruction method according to claim 1, wherein each acquisition of a temporal column image comprises the emission of emitting an incident wave successively by each of the elements of the selected column and the generation generating, for each pair of elements of the selected column, the first element of the pair designating the element located at the row and at the column that emitted the incident wave and the second element of the pair designating the element situated at the row and at the column that received the reflected wave, a temporal signal representing an amplitude over time of a reflected wave received by said second element, the temporal column image being formed by all the temporal signals of the selected column.

6. The reconstruction method according to claim 5, wherein constructing (18) each two dimensional column image comprises implementing a total focusing method.

7. The reconstruction method according to claim 1, wherein each acquisition of a temporal row image comprises successively emitting a plurality of incident waves by a plurality of elements of the selected row, each incident wave being emitted with a predetermined angle of incidence, and the generation of generating a temporal signal for each element of the selected row and for each incident wave with the predetermined angle of incidence, the temporal row image being formed by all the temporal signals of the selected row.

8. The reconstruction method according to claim 1, wherein each acquisition of a temporal column image comprises the successive emission of successively emitting a plurality of incident waves by a plurality of elements of the selected column, each incident wave being emitted with a predetermined angle of incidence, and the generation of generating a temporal signal for each element of the selected row and for each incident wave with the predetermined angle of incidence, the element designating the element located at the row mᵣ and at the column nₛ that received the reflected wave, the temporal column image being formed by all the temporal signals of the selected column.

9. The reconstruction method according to claim 7, wherein constructing each two-dimensional column image comprises implementing a plane wave imaging method.

10. The reconstruction method according to claim 1, wherein constructing each two-dimensional row image comprises detecting contours, so as to determine a profile of the part in the plane of said two-dimensional row image, and/or constructing each two-dimensional column image comprises detecting contours, so as to determine a profile of the part in the plane of said two-dimensional column image.

11. The reconstruction method according to claim 1, further comprising:
at each measurement point successively acquiring a plurality of temporal row images for various selected rows, each acquisition of a temporal row image comprising emitting an incident wave by one or more elements of the selected row of the matrix sensor and generating, for each of the elements of the selected row, a temporal signal representing an amplitude over time of a reflected wave received by said element, each temporal row image being formed by all the temporal signals of the elements of said selected row, and
for each scanning line and for each of the selected rows constructing, from all the temporal images of the line corresponding to said scanning line and to said selected row, a two-dimensional row image in a plane passing through the elements of the selected row, each two-dimensional row image being defined by a reflected wave amplitude at various points of the plane.

12. The reconstruction method according to claim 1, further comprising:
at each measurement point, successively acquiring a plurality of temporal column images for various selected columns, each acquisition of a temporal column image comprising emitting an incident wave by one or more elements of the selected column of the matrix sensor and the generating, for each of the elements of the selected column, a temporal signal representing an amplitude over time of a reflected wave received by said element, each temporal column image being formed by all the temporal signals of the elements of said selected column, and
for each increment line and for each of the selected columns, constructing, from all the temporal column images corresponding to said increment line and to said selected column, a two-dimensional column image in a plane passing through the elements of the selected column, each two-dimensional column image being defined by a reflected wave amplitude at various points of the plane.

13. The reconstruction method of claim 4, wherein constructing each two-dimensional row image comprises implementing a total focusing method.

14. The reconstruction method of claim 7, wherein constructing each two-dimensional row image comprises implementing a plane wave imaging method.
